(19) United States
(12) Patent Application Publication
(10) Pub. No.: US 2015/0148222 A1
(43) Pub. Date: May 28, 2015

(54) Effect of Support Oxides on Optimal Performance and Stability of ZPGM Catalyst Systems

(71) Applicant: Zahra Nazarpoor, Camarillo, CA (US)

(72) Inventor: Zahra Nazarpoor, Camarillo, CA (US)

(73) Assignee: Clean Diesel Technologies Inc. (CDTi), Ventura, CA (US)

(21) Appl. No.: 14/090,835

(22) Filed: Nov. 26, 2013

(51) Int. Cl. B01J 23/889

(52) U.S. Cl. CPC B01J 23/8892
USPC 502/324

(57) ABSTRACT

The present disclosure relates to selecting support oxide for ZPGM catalyst for optimal performance under TWC condition, for achieving enhanced catalyst activity, and improved thermal stability during aging. The selected active phase material may include a chemical composition that is substantially free from PGM, including a formulation of stoichiometric Cu—Mn spinel structure active phase with Niobium-Zirconium support oxide, which may include a washcoat of pure alumina coated on a suitable ceramic substrate. The disclosed Cu—Mn spinel structure active phase with Niobium-Zirconium support oxide may be applied in overcoat to maximize efficiency of ZPGM catalyst systems, which may exhibit enhanced catalytic activity properties that may increase with temperature, showing optimized performance purifying gases in TWC condition, and enhanced stability during aging.

### CROSS-REFERENCE TO RELATED APPLICATIONS

N/A

### BACKGROUND

1. Field of the Disclosure

This disclosure relates generally to catalytic systems and more particularly to effect of support oxides for Cu—Mn ZPGM catalyst, for optimal performance and stability of ZPGM catalyst systems for TWC application.

2. Background Information

The effects of support oxides, are well known in prior art for oxidation reactions of catalyst systems in TWC condition. Such catalysts have utility in a number of fields including the treatment of exhaust gas streams from internal combustion engines, such as automobile, truck and other gasoline-fueled engines. Typically, such prior art catalyst support composition may include platinum group metals, base metals, and rare earth metals which are often included in automotive catalyst support compositions, to store oxygen when air/fuel ratios are lean of stoichiometric, in this manner the oxygen can be released when air/fuel ratios become rich to combust the unburned hydrocarbons, and carbon monoxide.

Consequently, prior art TWC catalysts preferably use platinum group metals (PGM), which in turn drives up their cost and therefore the cost of catalytic applications. Accelerated catalyst reaction and optimal performance is desirable, which is particularly important for meeting increasingly stringent state and federal government vehicle emissions standards. Therefore, there is a continuing need to provide a cost effective catalyst system that is substantially free of PGM, capable to provide sufficient NOx, CO, and HC conversion to satisfy existing emissions standard regulations.

For the foregoing reasons, there is a need of improving the appropriate support oxide for catalyst systems, which may improve thermal stability and efficiency of catalyst oxidation reactions, employing a formulation free of platinum group metals (ZPGM) for cost effective manufacturing, and optimal performance in TWC condition.

### SUMMARY

It is an object of the present disclosure, to provide an appropriate support oxide for ZPGM catalyst which may exhibit optimized performance and enhanced thermal stability in TWC condition.

The optimized efficiency of ZPGM catalyst may be achieved by using Niobium-Zirconium support oxide in overcoat (OC), which may be prepared employing co-precipitation synthesis method, for achieving optimized catalyst activity, and improved thermal stability during aging.

According to an embodiment, the composition of the active phase in OC with Niobium-Zirconium support oxide within disclosed ZPGM catalyst system, may include a stoichiometric Cu—Mn spinel active phase with Niobium-Zirconia support oxide, where the material may be dried and calcined at about 600° C. to form a spinel structure.

According to another embodiment in the present disclosure, fresh and hydrothermally aged samples of ZPGM metal catalyst may be prepared to analyze/measure the catalytic activity of the Cu—Mn spinel active phase with Niobium-Zirconium support oxide applied in OC, to compare with corresponding samples with Cu—Mn spinel active phase with Praseodymium-doped Zirconium support oxide applied in OC.

Comparison may include the catalytic activity and influence of applying different support oxides to compare the stability of the catalysts, employing fresh and hydrothermally aged samples for testing under steady state sweep test for selecting the best performance in TWC condition.

The selected support oxide for optimized performance in TWC condition, may include applying active phase in OC with Niobium-Zirconium support oxide, which may include a WC of pure alumina applied on a suitable ceramic substrate, with total loading of about 120 g/L.

The present disclosure may provide solutions for optimized performance of TWC catalyst systems, employing an Cu—Mn spinel active phase in OC with Nb—Zr support oxide catalyst substantially free of PGM, for achieving enhanced stability during aging, improving light-off performance when compared to catalyst systems employing other support oxides.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 shows effect of support oxide on NO, CO, and HC percent conversion, employing fresh catalyst samples under steady state sweep condition, at inlet temperature of about 450° C. and space velocity (SV) of 40,000 h⁻¹, according to an embodiment.

FIG. 2 shows effect of support oxide on NO, CO, and HC percent conversion, employing hydrothermally aged samples at 900° C. for about 4 hours under steady state sweep condition, at inlet temperature of about 450° C. and space velocity (SV) of 40,000 h⁻¹, according to an embodiment.

FIG. 3 shows effect of support oxide on NO, CO, and HC percent conversion, employing hydrothermally aged samples at 1000° C. for about 4 hours under steady state sweep condition, at inlet temperature of about 450° C. and space velocity (SV) of 40,000 h⁻¹, according to an embodiment.

### DETAILED DESCRIPTION

In the following detailed description, reference is made to the accompanying drawings, which form a part hereof. In the drawings, which are not necessarily to scale or to proportion, similar symbols typically identify similar components, unless context dictates otherwise with emphasis being placed upon illustrating the principles of the invention. The illustrative embodiments described in the detailed description, drawings and claims, are not meant to be limiting. Other embodiments may be used and/or other changes may be made without departing from the spirit or scope of present disclosure.

### Definitions

As used here, the following terms may have the following definitions:

“Platinum group Metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat layer.

“Milling” refers to the operation of breaking a solid material into a desired grain or particle size.

“Co-precipitation” may refer to the carrying down by a precipitate of substances normally soluble under the conditions employed.

“Calcination” refers to a thermal treatment process applied to solid materials, in presence of air, to bring about a thermal decomposition, phase transition, or removal of a volatile fraction at temperatures below the melting point of the solid materials.

“R value” refers to the number obtained by dividing the reducing potential by the oxidizing potential of materials in a catalyst.

“Rich condition” refers to exhaust gas condition with an R value above 1.

“Lean condition” refers to exhaust gas condition with an R value below 1.

“Air/Fuel ratio” or “A/F ratio” refers to the weight of air divided by the weight of fuel.

“Three-Way Catalyst” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

### Description of the Drawings

The present disclosure may generally provide methods to determine the effect of support oxides on performance and stability of active phase catalyst applied in overcoat, employing a ZPGM formulation. The disclosed active phase catalyst material may include a chemical composition that is practically free from PGM, which may be used for a plurality of catalyst applications, and more particularly, in TWC systems. The catalyst material may be prepared from a stoichiometric Cu—Mn spinel structure, CuMn₂O₄ supported on different support oxide by using co-precipitation method or any other preparation technique known in the art.

### Composition and Preparation of Supported Cu—Mn Active Phase as ZPGM Catalyst

The preparation of disclosed active phase catalyst material may begin by milling the support oxide to make aqueous slurry.

The Cu—Mn solution may be prepared by mixing from about 1 to about 2 hours, the appropriate amount of Mn nitrate solution (MnNO₃) and Cu nitrate solution (CuNO₃), where the suitable copper loadings may include loadings in a range of about 10% to about 15% by weight. Suitable manganese loadings may include loadings in a range of about 15% to about 25% by weight. The next step is precipitation of Cu—Mn nitrate solution on support oxide aqueous slurry, for which an appropriate amount of one or more of sodium hydroxide (NaOH) solution, sodium carbonate (Na₂CO₃) solution, ammonium hydroxide (NH₄OH) solution, tetraethyl ammonium hydroxide (TEAH) solution, and other suitable base solutions may be added to the Cu—Mn/support oxide slurry. For the precipitation process, the pH of the Cu—Mn/support oxide slurry may be adjusted at the range of about 7-9 using suitable base solution by adding appropriate amount of base solution. The precipitated slurry may be aged for a period of time of about 12 to 24 hours under continued stirring at room temperature, and then may be deposited as overcoat employing vacuum dosing and coating systems. In the present disclosure, a plurality of capacities of OC loadings may vary from about 60 g/L to about 200 g/L, in this disclosure particularly about 120 g/L.

According to embodiments in the present disclosure, treatment of the OC may be enabled employing suitable drying and heating processes. A commercially-available air knife drying systems may be employed for drying the OC. Heat treatments may be performed using commercially-available firing (calcination) systems. The treatment may take from about 2 hours to about 6 hours, preferably about 4 hours, at a temperature within a range of about 550° C. to about 650° C., preferably at about 600 ° C.

According to principles in the present disclosure, fresh and aged samples of ZPGM for each one of the selected support oxides, may be subjected to testing under steady state sweep test condition to determine the R values at NO/CO cross over at a selected temperature.

### Example #1

### Cu—Mn Spinel Active Phase with Nb₂O₅—ZrO₂Support Oxide

Example #1 may describe the preparation of ZPGM samples including Cu—Mn spinel supported on Nb₂O₅—ZrO₂. The Nb₂O₅—ZrO₂support oxide may have Nb₂O₅ loadings of about 15% to about 30% by weight, preferably about 25% and ZrO₂ loadings of about 70% to about 85% by weight, preferably about 75%. ZPGM catalyst may include substrate, washcoat, and overcoat layer.

WC layer may be prepared by milling pure alumina to prepare the slurry and coat on a suitable ceramic substrate, using a cordierite material with honeycomb structure with loading of 120 g/L, then fired at about 550° C. for about 4 hours.

OC layer may be prepared by milling separately Nb₂O₅—ZrO₂ support oxide to make the slurry. Prepare solution of Cu nitrate and Mn nitrate with the stoichiometric of CuMn₂O₄ spinel structure active phase slurry and mix for about 1 hour to about 2 hours. For the precipitation of Cu—Mn nitrate solution on Nb₂O₅—ZrO₂ support oxide aqueous slurry, the pH of the Cu—Mn/Nb₂O₅—ZrO₂ slurry may be adjusted at the range of about pH 7-9, preferably within about pH 8-8.5, adding appropriate amount of base solution as described. The precipitated slurry may be aged for a period of time of about 12 to 24 hours under continued stirring at room temperature.

After precipitation, the OC slurry may be coated on WC layer of alumina, with an OC loading from about 60 g/L to about 200 g/L, in this disclosure particularly about 120 g/L. The resulting material may be calcined at a temperature of about 600° C. for about 5 hours.

### Example #2

### Cu—Mn Spinel Active Phase with Pr₆O₁₁—ZrO₂ Support Oxide

Example #2 may describe the preparation of ZPGM samples including Cu—Mn spinel supported on Pr₆O₁₁—ZrO₂. The Pr₆O₁₁—ZrO₂ support oxide may have Pr₆O₁₁ loadings of about 5% to about 15% by weight, preferably about 10% and ZrO₂ loadings of about 85% to about 95% by weight, preferably about 90%. ZPGM catalyst may include substrate, washcoat, and overcoat layer.

The disclosed Cu—Mn spinel structure with Pr₆O₁₁—ZrO₂ support oxide catalyst material may be prepared, employing exactly the same procedure mentioned above for Cu—Mn spinel structure with Nb₂O₅—ZrO₂ support oxide in Example#1, except using Pr₆O₁₁—ZrO₂ support oxide instead of Nb₂O₅—ZrO₂ support oxide.

According to an embodiment, the steady state sweep test may be performed employing fresh and aged samples coated with ZPGM catalyst applied in OC for comparison of test results to select the best performance of NO, CO, and HC conversion, employing fresh and thermally aged samples, which may be prepared according with formulation and instructions of Example #1.

For comparison of best performance of R value at NO, CO, and HC cross over respectively, and to select the best performance of NO, CO, and HC conversion. A second set of test samples may be prepared, applying Cu—Mn spinel structure active phase with Pr₆O₁₁—ZrO₂ support oxide catalyst applied in OC, which may include a washcoat of pure alumina. This second set of fresh and thermally aged samples may be prepared according with formulation and instructions of Example #2.

### Steady State Cycle Sweep Test Procedure

The steady state sweep test may be carried out employing a test reactor increasing the inlet temperature to about 450° C., employing 11-point R values from about 2.0 (rich condition) to about 0.80 (lean condition) to measure the CO, NO, and HC conversions at hydrothermal temperature of 450° C. selected because of the application of underflow condition.

The space velocity (SV) may be adjusted at about 40,000 h⁻¹. The gas feed employed for the test may be a standard TWC gas composition, with variable O₂ concentration in order to adjust R value from rich condition to lean condition during testing. The standard TWC gas composition may include about 8,000 ppm of CO, about 400 ppm of C₃H₆, about 100 ppm of C₃H₈, about 1,000 ppm of NOx, about 2,000 ppm of H₂, 10% of CO₂, and 10% of H₂O. The quantity of O₂ in the gas mix may be oscillated to represent the three-way condition of the control loop.

The following examples are intended to illustrate the scope of the disclosure. It is to be understood that other procedures known to those skilled in the art may alternatively be used.

### Effect of Support Oxides on Performance of Fresh Cu—Mn Catalyst

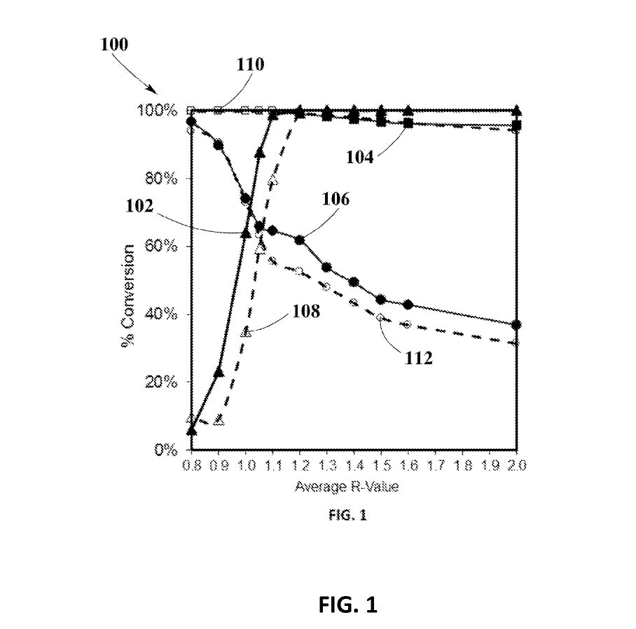

The graph of FIG. 1 shows steady state sweep test results, for disclosed ZPGM catalyst with Cu—Mn spinel supported on Nb₂O₅—ZrO₂ and Pr₆O₁₁—ZrO₂. Fresh samples may be prepared employing formulation described in Example #1, for comparison with fresh samples prepared as per Example #2.

The steady state sweep test may determine the R-value at NO/CO, and NO/HC cross over, for sweep test comparison 100 with test results of fresh samples, which may include a formulation with stoichiometric Cu_{1.0}Mn_{2.0} spinel as active phase in OC with Nb₂O₅—ZrO₂ support oxide, with total loading of about 120 g/L, for comparison with corresponding samples which may include a formulation with stoichiometric Cu_{1.0}Mn_{2.0} as spinel active phase in OC with Pr₆O₁₁—ZrO₂ support oxide, with total loading of about 120 g/L.

As may be seen in FIG. 1, the test results of percent conversion of fresh samples prepared as per Example #1, using Nb₂O₅—ZrO₂ as support oxide has been designated with solid lines, and identified as Nb2O5-ZrO2 fresh NO curve 102, Nb2O5-ZrO2 fresh CO curve 104, and Nb2O5—ZrO2 fresh HC curve 106. The NO/CO crosses over takes place at the specific R value of 1.15, where the NO/CO conversion is about 100%. Additionally, the NO/HC crosses over takes place at the specific R value of 1.02, where the NO/HC conversion is about 72%.

The graph of FIG. 1 also shows steady state sweep test results of percent conversion of fresh samples as per Example #2, using Pr₆O₁₁—ZrO₂ support oxide. To facilitate sweep test comparison 100 have been designated with broken lines as Pr6O11-ZrO2 fresh NO curve 108, Pr6O11-ZrO2 fresh CO curve 110, and Pr6O11-ZrO2 fresh HC curve 112. The NO/CO crosses over takes place at the specific R value of 1.20, where the NO/CO conversion is about 99.3%. Additionally, the NO/HC cross over takes place at the specific R value of 1.052, where the NO and HC conversion is about 62.0%.

Test results of FIG. 1 shows the effect of selecting Nb2O5-ZrO2 as support oxide for Cu—MN ZPGM samples, prepared as per Example #1, which may exhibit enhanced performance in TWC sweep condition with lower NO/CO cross over R value and higher NO and HC conversion over R window, compared to ZPGM samples with Pr₆O₁₁—ZrO₂ support oxide, prepared as per Example #2.

Effect of support oxides on performance of Cu—MN catalyst after aging at 900° C.

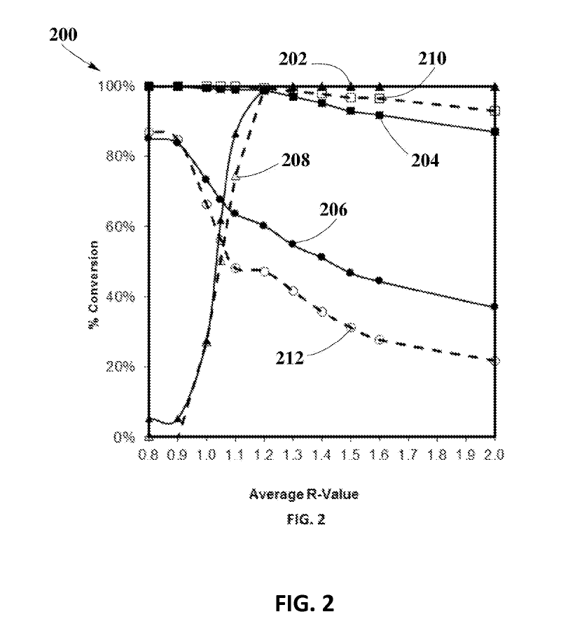

The graph of FIG. 2 shows steady state sweep test results of disclosed ZPGM catalyst samples hydrothermally aged with 10% steam at about 900° C. for about 4 hours. Aged samples may be prepared employing formulation as described in Example #1, for comparison with aged samples prepared as per Example #2.

The steady state sweep test may determine the R-value at NO/CO, and NO/HC cross over, for sweep test comparison 200 with test results of fresh samples, which may include a formulation with stoichiometric Cu_{1.0}Mn_{2.0} spinel as active phase in OC with Nb₂O₅—ZrO₂ support oxide, with total loading of about 120 g/L, for comparison with corresponding samples which may include a formulation with stoichiometric Cu_{1.0}Mn_{2.0} as spinel active phase in OC with Pr₆O₁₁—ZrO₂ support oxide, with total loading of about 120 g/L.

As may be seen in FIG. 2, the test results of percent conversion of aged samples prepared as per Example #1, using Nb₂O₅—ZrO₂ as support oxide has been designated with solid lines, and identified as Nb2O5-ZrO2 aged NO curve 202, Nb2O5-ZrO2 aged CO curve 204, and Nb2O5-ZrO2 aged HC curve 206. The NO/CO crosses over takes place at the specific R value of 1.20, where the aged NO/CO conversion is substantially about 98.7%. Additionally, the aged NO/HC crosses over takes place at the specific R value of 1.052, where the NO/HC conversion is substantially about 66.5%.

The graph of FIG. 2 also shows steady state sweep test results of percent conversion of aged samples prepared as per Example #2, using Pr₆O₁₁—ZrO₂ support oxide. To facilitate sweep test comparison 200 have been designated with broken lines and identified as Pr6O11-ZrO2 aged NO curve 208, Pr6O11-ZrO2 aged CO curve 210, and Pr6O11-ZrO2 aged HC curve 212. The NO/CO crosses over takes place at the specific R value of 1.20, where the NO/CO conversion is about 99.4%. Additionally, the NO/HC crosses over takes place at the specific R value of 1.052, where the NO/HC conversion is about 55.0%.

Test results of FIG. 2 shows the effect of selecting Nb2O5-ZrO2 as support oxide for Cu—Mn ZPGM samples, prepared as per Example #1, which exhibit enhanced performance, NO and HC conversion under sweep window, and better thermal stability, compared to ZPGM samples with stoichiometric Cu—Mn spinel active phase in overcoat with Pr₆O₁₁—ZrO₂ support oxide, prepared as per Example #2.

### Effect of Support Oxides on Performance of Cu—Mn Catalyst After Aging at 1000° C.

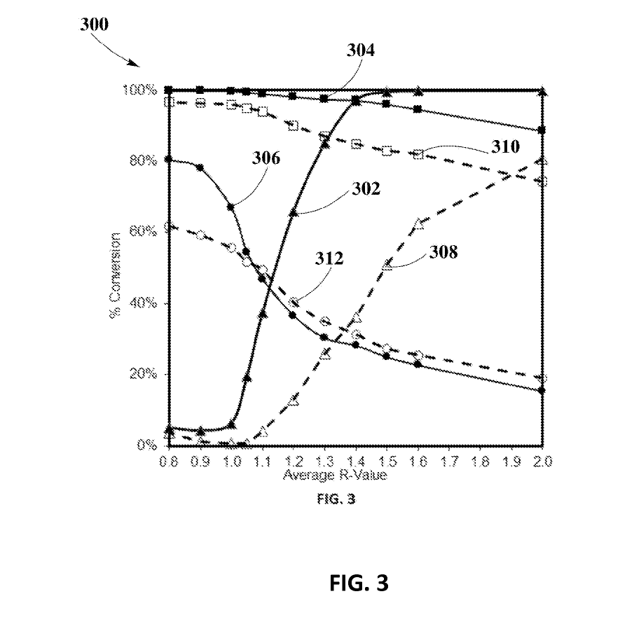

The graph of FIG. 3 shows steady state sweep test results of disclosed ZPGM catalyst samples hydrothermally aged with 10% steam at about 1000° C. for about 4 hours. Aged samples may be prepared employing formulation as described in Example #1, for comparison with aged samples prepared as per Example #2.

The steady state sweep test may determine the R-value at NO/CO, and NO/HC cross over, for sweep test comparison 300 with test results of aged samples, which may include a formulation with stoichiometric Cu_{1.0}Mn_{2.0} spinel active phase in OC with Nb₂O₅—ZrO₂ support oxide, with total loading of 120 g/L, for comparison with corresponding samples which may include a formulation with stoichiometric Cu_{1.0}Mn_{2.0} spinel active phase in OC with Pr₆O₁₁—ZrO₂ support oxide, with total loading of about 120 g/L.

As may be seen in FIG. 3, shows test results of percent conversion of aged samples prepared as per

Example #1, using Nb₂O₅—ZrO₂ as support oxide, which has been designated with solid lines and identified as Nb2O5-ZrO2 aged NO curve 302, Nb2O5-ZrO2 aged CO curve 304, and Nb2O5-ZrO2 aged HC curve 306. The NO/CO crosses over takes place at the specific R value of 1.40, where the NO/CO conversion is about 97.1%. Additionally, the NO/HC crosses over takes place at the specific R value of 1.12, where the NO/HC conversion is about 45%.

The graph of FIG. 3 also shows steady state sweep test results of percent conversion of aged samples prepared as per Example #2, using Pr₆O₁₁—ZrO₂support oxide. To facilitate sweep test comparison 300 have been designated with broken lines and identified as Pr6O11-ZrO2 aged NO curve 308, Pr6O11-ZrO2 aged CO curve 310, and Pr6O11-ZrO2 aged HC curve 312. The NO/CO cross over takes place at the specific R value of 1.90, where the NO/CO conversion is about 75.5%. Additionally, the NO/HC crosses over takes place at the specific R value of 1.37, where the NO/HC conversion is about 33%.

Test results of FIG. 3, shows the effect of selecting Nb2O5-ZrO2 as support oxide for Cu—Mn ZPGM samples prepared as per Example #1, which exhibit enhanced performance of NO and CO conversion under sweep window, and better thermal stability compared to ZPGM samples with stoichiometric Cu—Mn spinel active phase in overcoat with Pr₆O₁₁—ZrO₂ support oxide, prepared as per Example #2 including hydrothermal aging at 1000° C. This test results shows the significant improvement of thermal stability of Cu—Mn spinel ZPGM catalyst by using Nb₂O₅—ZrO₂ support oxide.

In addition, disclosed ZPGM catalyst system with Nb₂O₅—ZrO₂ support oxide achieved optimized performance in TWC condition, with lower NO/CO cross over R value, providing optimal thermal stability at different temperatures.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalytic composition, comprising:
stoichiometric Cu—Mn spinel; and
niobium-zirconia support oxide;
wherein the stoichiometric Cu—Mn spinel is in active phase and is calcined at about 600° C.

2. The composition of claim 1, wherein the niobium-zirconia support oxide has a general formula of N b₂O₅—ZrO₂.

3. The composition of claim 1, wherein the niobium-zirconia support oxide provides a lower NO/CO cross over R value than Pr₆O₁₁—ZrO₂ support oxide.

4. The composition of claim 3, wherein the R value is about 1.20.

5. The composition of claim 1, wherein the niobium-zirconia support oxide provides a higher NO conversion rate than Pr₆O₁₁—ZrO₂ support oxide.

6. The composition of claim 1, wherein the niobium-zirconia support oxide provides a higher HC conversion rate than Pr₆O₁₁—ZrO₂ support oxide.

7. The composition of claim 1, wherein the stoichiometric Cu—Mn spinel is aged.

8. The composition of claim 1, wherein the catalytic composition is aged.

9. The composition of claim 1, wherein the niobium-zirconia support oxide is aged at 900° C.

10. The composition of claim 9, wherein the aging is hydrothermal aging.

11. The composition of claim 9, wherein the niobium-zirconia support oxide provides a higher NO conversion rate than Pr₆O₁₁—ZrO₂ support oxide.

12. The composition of claim 1, wherein the niobium-zirconia support oxide is aged at 1000° C.

13. The composition of claim 12, wherein the aging is hydrothermal aging.

14. The composition of claim 12, wherein the niobium-zirconia support oxide provides a higher NO conversion rate than Pr₆O₁₁—ZrO₂ support oxide.

15. The composition of claim 1, wherein the NO/CO conversion is about 98.7%.

16. The composition of claim 1, wherein the NO/HC conversion is about 66.5%.
